(19) United States
(12) Patent Application Publication
(10) Pub. No.: US 2025/0223215 A1
(43) Pub. Date: Jul. 10, 2025

(54) System and Method for Glass Furnace Raft Monitoring and Control

(71) Applicant: Vitro Flat Glass LLC, Cheswick, PA (US)

(72) Inventors: Priyadarshi Mahapatra, Cheswick, PA (US); Alan Dum, Cheswick, PA (US); Yu Jiao, Cheswick, PA (US); Russell W. Schrier, Cheswick, PA (US); Wei Xu, Cheswick, PA (US)

(21) Appl. No.: 19/008,013

(22) Filed: Jan. 2, 2025

Related U.S. Application Data
(60) Provisional application No. 63/617,440, filed on Jan. 4, 2024.

(51) Int. Cl. C03B 5/24; C03B 1/00

(52) U.S. Cl. CPC C03B 5/24; C03B 1/00

(57) ABSTRACT

A system, method, and computer program product for monitoring and control of unmelted batch material in a glass melt furnace including at least one camera configured to take image data of an interior of the glass melt furnace, and at least one processor programmed or configured to: receive the image data; define a region of interest in the image data; identify a coverage area of the unmelted batch material in the region of interest; compare the coverage area of the unmelted batch material with a predetermined setpoint; and determine deviation of the coverage area of the unmelted batch material from the predetermined setpoint. In response to deviation of the coverage area of the unmelted batch material from the predetermined setpoint, a crown temperature distribution in a longitudinal direction of the interior of the glass melt furnace is adjusted based on a temperature control model.

### CROSS-REFERENCE TO RELATED APPLICATION

This application claims priority to U.S. Provisional Patent Application No. 63/617,440, filed on Jan. 4, 2024, the disclosure of which is hereby incorporated by reference in its entirety.

### BACKGROUND

### Field

This disclosure relates generally to monitoring and controlling operation of glass melting furnaces for automating their operation, and, in some non-limiting embodiments or aspects, to systems, methods, and computer program products for controlling and monitoring unmelted batch material in glass melting furnaces.

### Technical Considerations

A continuous glass melting furnace is a crucial component in the glass manufacturing process, designed to melt raw materials and maintain a consistent, continuous flow of molten glass for further processing. These furnaces are commonly used in the production of various types of glass, such as flat glass (used in windows and mirrors) or container glass (used in bottles and jars).

Raw materials, typically including silica sand, soda ash, limestone, and other additives, are prepared in precise proportions depending on a desired glass compositions and are loaded into a melting tank of the glass melting furnace through a hopper or a conveyor system. The batch of raw materials is heated to an extremely high temperature (often exceeding 2,000 degrees Fahrenheit (1,100 degrees Celsius), thereby causing the raw materials to melt and fuse together to form a homogenous molten glass. As the batch of raw materials advances through the melting tank, the batch is gradually melted such that, by the time the molten glass reaches an exit of the melting tank, it is free of unmelted batch material.

Existing glass melting furnaces are typically operated under a control scheme where a controller is used to change furnace fuel flow rates to one or more burners to maintain a desired furnace temperature profile within the furnace, as measured by one or more temperature sensors. The furnace operator selects a desired furnace temperature profile based on current operating conditions and the desired glass “recipe”. The furnace temperature profile is largely determined by heuristics, where melt behavior is visually observed through one or more ports in the furnace and the fuel flow rate is adjusted to maintain a desired unmelted batch material coverage in the melting tank. The selected furnace temperature profile is based on a balance of efficiency compared to glass quality. Too high of a temperature will melt all of the batch material but will require too much fuel, whereas too low of a temperature will not melt all of the batch material, thereby creating defects in the glass.

There is a need in the art for an improved system and method for controlling the operation of glass melting furnaces.

### SUMMARY

Disclosed are systems, methods, and computer program products for controlling and monitoring unmelted batch material in glass melting furnaces.

In accordance with some embodiments or aspects of the present disclosure, provided is a system for monitoring and control of unmelted batch material in a glass melt furnace. The system may include at least one camera configured to take image data of an interior of the glass melt furnace, and at least one processor, wherein the at least one processor is programmed or configured to receive the image data from the at least one camera. The at least one processor may be further programmed or configured to define a region of interest in the image data, the region of interest corresponding to one or more zones in a glass melt portion in the interior of the glass melt furnace. The at least one processor may be further programmed or configured to identify a coverage area of the unmelted batch material in each of the one or more zones based on at least one characteristic of the image data, compare the coverage area of the unmelted batch material with a predetermined setpoint, and determine deviation of the coverage area of the unmelted batch material from the predetermined setpoint. In response to deviation of the coverage area of the unmelted batch material from the predetermined setpoint, the at least one processor may be further programmed or configured to adjust a crown temperature distribution in a longitudinal direction of the interior of the glass melt furnace based on a temperature control model. The model may include determining a desired temperature change in at least one of the one or more zones, the desired temperature change corresponding to a desired change in the coverage area of the unmelted batch material. The model further may include transforming the desired temperature change into a plurality of crown temperature trim setpoints using a temperature distribution matrix. A computer program product for monitoring and control of unmelted batch material in a glass melt furnace, and a method for monitoring and control of unmelted batch material in a glass melt furnace are also disclosed.

Features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

FIG. 1 is a representative schematic diagram of a glass melt furnace in accordance with some embodiments or aspects of the present disclosure;

FIG. 2 is a diagram of a non-limiting embodiment or aspect of components of a system for monitoring and control of unmelted batch material shown in FIG. 1;

FIGS. 3-4 are schematic top views of a furnace having a system for monitoring and control of unmelted batch material;

FIG. 5 is a plot of an area of unmelted batch material in various portions of a glass melt furnace as a function of time;

FIG. 6 is a plot of temperatures in various areas of a glass melt furnace as a function of time;

FIG. 7 is a plot of crown temperature profile changes at a fill side and a waist side of a glass melt furnace during a first empirical test;

FIG. 8 is a plot of a crown temperature profile during the first empirical test;

FIG. 9 is a plot of crown temperature profile changes at a fill side and a waist side of a glass melt furnace during a second empirical test;

FIG. 10 is a plot of a crown temperature profile during the second empirical test;

FIG. 11 is a plot of crown temperature profile changes as a function of time;

FIG. 12A is a plot of deviation in an area of unmelted batch material as a function of time;

FIG. 12B is a plot of temperature changes at a fill end of a furnace as a function of time;

FIG. 12C is a plot of temperature changes at a waist end of a furnace as a function of time;

FIG. 13 is a plot comparing model vs. measurement of deviation in an area of unmelted batch material as a function of time;

FIG. 14 is a screenshot of a representative graphical user interface of a system for monitoring and control of unmelted batch material in accordance with some embodiments or aspects of the present disclosure;

FIG. 15 is a screenshot of another representative graphical user interface of a system for monitoring and control of unmelted batch material; and

FIG. 16 is a flowchart of non-limiting embodiments or aspects of a process for monitoring and control of unmelted batch material.

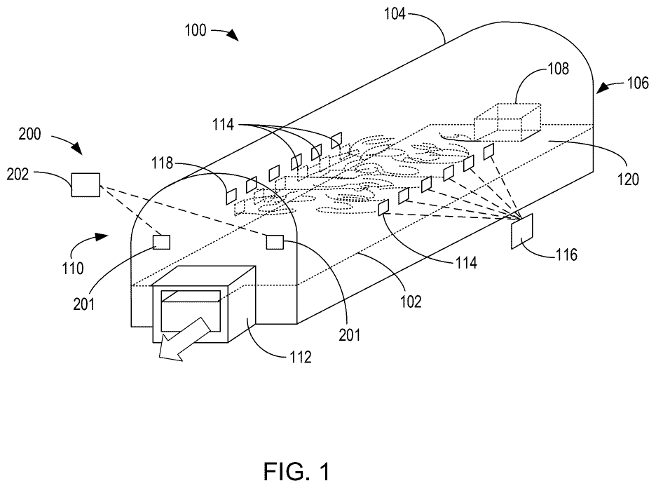

In FIGS. 1-16, like characters refer to the same components and elements, as the case may be, unless otherwise stated.

### Description

The following description is provided to enable those skilled in the art to make and use the described aspects contemplated for carrying out the disclosure. Various modifications, equivalents, variations, and alternatives, however, will remain readily apparent to those skilled in the art. Any and all such modifications, variations, equivalents, and alternatives are intended to fall within the spirit and scope of the present disclosure.

As used herein, the singular form of “a”, “an”, and “the” includes plural referents unless noted otherwise. With respect to the use of any plural and/or singular terms herein, those having skill in the art can translate from the plural to the singular and/or from the singular to the plural as is appropriate to the context and/or application. The various singular/plural permutations are not expressly set forth herein for sake of clarity.

Spatial or directional terms, such as “left”, “right”, “inner”, “outer”, “above”, “below”, and the like, relate to the embodiments or aspects as shown in the drawing figures and are not to be considered as limiting as the embodiments or aspects can assume various alternative orientations.

All numbers used in the specification and claims are to be understood as being modified in all instances by the term “about”. By “about” is meant plus or minus twenty-five percent of the stated value, such as plus or minus ten percent of the stated value. However, this should not be considered as limiting to any analysis of the values under the doctrine of equivalents.

Unless otherwise indicated, all ranges or ratios disclosed herein are to be understood to encompass the beginning and ending values and any and all subranges or sub ratios subsumed therein. For example, a stated range or ratio of “1 to 10” should be considered to include any and all subranges or sub ratios between (and inclusive of) the minimum value of 1 and the maximum value of 10; that is, all subranges or sub ratios beginning with a minimum value of 1 or more and ending with a maximum value of 10 or less. The ranges and/or ratios disclosed herein represent the average values over the specified range and/or ratio.

The terms “first”, “second”, and the like are not intended to refer to any particular order or chronology, but refer to different conditions, properties, or elements.

All documents referred to herein are “incorporated by reference” in their entirety.

The term “at least” is synonymous with “greater than or equal to”.

The term “not greater than” is synonymous with “less than or equal to”.

In some instances, one or more components may be referred to herein as “configured to,” “operative,” “adapted,” etc. Those skilled in the art will recognize that “configured to” can generally encompass active-state components and/or inactive-state components and/or standby-state components, unless context requires otherwise.

Some aspects may be described using the expression “coupled” and “connected” along with their derivatives. It should be understood that these terms are not intended as synonyms for each other. For example, some aspects may be described using the term “connected” to indicate that two or more elements are in direct physical or electrical contact with each other. In another example, some aspects may be described using the term “coupled” to indicate that two or more elements are in direct physical or electrical contact. The term “coupled,” however, also may mean that two or more elements are not in direct contact with each other, but yet still co-operate or interact with each other.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components.

Some non-limiting embodiments or aspects may be described herein in connection with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, etc.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended to have a meaning in the sense that one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

In those instances where a convention analogous to “A and/or B” is used, in general such a construction is intended to have a meaning in the sense that one having skill in the art would understand the convention (e.g., “A and/or B” would include but not be limited to systems that have A alone, B alone, or A and B together).

The term “includes” is synonymous with “comprises”.

It is noted that any reference to “an embodiment”, “one aspect”, or “an aspect” means that a particular feature, structure, or characteristic described in connection with the embodiment or aspect is included in at least one embodiment or aspect. Thus, appearances of the phrases “in one embodiment”, “in one aspect”, or “in an aspect” in various places throughout the specification are not necessarily all referring to the same aspect or embodiment. Furthermore, the particular features, structures or characteristics may be combined in any suitable manner in one or more embodiments or aspects.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Float glass furnaces are widely used in the glass industry for producing high-quality flat glass. The fundamental concept involves melting raw materials, such as silica, soda ash, and limestone, in a furnace and allowing the molten glass to “float” on a bath of molten material, resulting in a flat and uniform glass ribbon. Traditional float glass furnaces have inherent limitations, such as thermal inefficiencies, material wastage, and structural vulnerabilities, which this patent application seeks to address.

The following numbered clauses are illustrative of various aspects of the disclosure:

Clause 1: A system for monitoring and control of unmelted batch material in a glass melt furnace, the system comprising: at least one camera configured to take image data of an interior of the glass melt furnace; and at least one processor, wherein the at least one processor is programmed or configured to: receive the image data from the at least one camera; define a region of interest in the image data, the region of interest corresponding to one or more zones in a glass melt portion in the interior of the glass melt furnace; identify a coverage area of the unmelted batch material in each of the one or more zones based on at least one characteristic of the image data; compare the coverage area of the unmelted batch material with a predetermined setpoint; determine deviation of the coverage area of the unmelted batch material from the predetermined setpoint; and in response to deviation of the coverage area of the unmelted batch material from the predetermined setpoint, adjust a crown temperature distribution in a longitudinal direction of the interior of the glass melt furnace based on a temperature control model comprising: determining a desired temperature change in at least one of the one or more zones, the desired temperature change corresponding to a desired change in the coverage area of the unmelted batch material; and transforming the desired temperature change into a plurality of crown temperature trim setpoints using a temperature distribution matrix.

Clause 2: The system according to clause 1, wherein the temperature distribution matrix comprises a number of temperature trim multipliers corresponding to the plurality of crown temperature trim setpoints.

Clause 3: The system according to clause 1 or 2, wherein the desired temperature change comprises a weighted fill side temperature change and a weighted waist side temperature change.

Clause 4: The system according to any of clauses 1 to 3, wherein adjusting the crown temperature distribution comprises increasing or decreasing a supply of gas to at least one burner.

Clause 5: The system according to any of clauses 1 to 4, wherein the at least one processor is further programmed or configured to: identify a melt front of the unmelted batch material in each of the one or more zones based on at least one characteristic of the image data; compare the melt front of the unmelted batch material with a predetermined melt front setpoint; determine deviation of the melt front of the unmelted batch material from the predetermined melt front setpoint; and, in response to deviation of the melt front of the unmelted batch material from the predetermined melt front setpoint, adjust the crown temperature distribution using the temperature control model.

Clause 6: The system according to any of clauses 1 to 5, wherein the at least one processor is programmed or configured to generate an alert in response to determining that the coverage area of the unmelted batch material is outside the predetermined threshold range.

Clause 7: The system according to any of clauses 1 to 6, wherein the alert is at least one of a visual alert and an audio alert.

Clause 8: The system according to any of clauses 1 to 7, wherein the at least one characteristic of the image data is an image contrast value.

Clause 9: The system according to any of clauses 1 to 8, wherein the at least one characteristic of the image data is an image brightness value.

Clause 10: The system according to any of clauses 1 to 9, wherein the one more zones is defined between an entrance and a bubbler area of the glass melt furnace.

Clause 11: The system according to any of clauses 1-10, wherein the one or more zones comprise a fill zone at the entrance of the glass melt furnace, a bubbler zone at the bubbler area of the glass melt furnace, and an intermediate zone between the fill zone and the bubbler zone.

Clause 12: The system according to any of clauses 1 to 11, wherein the at least one processor is programmed or configured to average the image data over a predefined period of time to account for heat-related disturbances in the image data.

Clause 13: The system according to any of clauses 1 to 12, wherein the at least one camera is a pair of cameras positioned at an exit of the glass melt furnace.

Clause 14: The system according to any of clauses 1 to 13, wherein the at least one camera comprises a liquid-cooled jacket.

Clause 15: The system according to any of clauses 1 to 14, wherein the liquid-cooled jacket comprises a nitrogen purge for cleaning a lens of the at least one camera.

Clause 16: The system according to any of clauses 1 to 15, wherein the at least one camera operates in a visible light spectrum.

Clause 17: The system according to any of clauses 1 to 16, wherein the at least one camera is configured to take black and white still or video images of the interior of the glass melt furnace.

Clause 18: The system according to any of clauses 1 to 17, wherein the at least one camera is configured to take color still or video images of the interior of the glass melt furnace.

Clause 19: A computer program product for monitoring and control of unmelted batch material in a glass melt furnace, the computer program product comprising at least one non-transitory computer-readable medium including one or more instructions that, when executed by at least one processor, cause the at least one processor to: receive image data of an interior of the glass melt furnace from at least one camera; define a region of interest in the image data, the region of interest corresponding to one or more zones in a glass melt portion in the interior of the glass melt furnace; identify a coverage area of the unmelted batch material in each of the one or more zones based on at least one characteristic of the image data; compare the coverage area of the unmelted batch material with a predetermined setpoint; determine deviation of the coverage area of the unmelted batch material from the predetermined setpoint; and, in response to deviation of the coverage area of the unmelted batch material from the predetermined setpoint, adjust a crown temperature distribution in a longitudinal direction of the interior of the glass melt furnace based on a temperature control model comprising: determining a desired temperature change in at least one of the one or more zones, the desired temperature change corresponding to a desired change in the coverage area of the unmelted batch material; and transforming the desired temperature change into a plurality of crown temperature trim setpoints using a temperature distribution matrix.

Clause 20: The computer program product according to clause 19, wherein the temperature distribution matrix comprises a number of temperature trim multipliers corresponding to the plurality of crown temperature trim setpoints.

Clause 21: The computer program product according to clause 19 or 20, wherein the desired temperature change comprises a weighted fill side temperature change and a weighted waist side temperature change.

Clause 22: The computer program product according to any of clauses 19 to 21, wherein adjusting the crown temperature distribution comprises increasing or decreasing a supply of gas to at least one burner.

Clause 23: The computer program product according to any of clauses 19 to 22, wherein the one or more instructions, when executed by at least one processor, further cause the at least one processor to: identify a melt front of the unmelted batch material in each of the one or more zones based on at least one characteristic of the image data; compare the melt front of the unmelted batch material with a predetermined melt front setpoint; determine deviation of the melt front of the unmelted batch material from the predetermined melt front setpoint; and, in response to deviation of the melt front of the unmelted batch material from the predetermined melt front setpoint, adjust the crown temperature distribution using the temperature control model.

Clause 24: The computer program product according to any of clauses 19 to 23, wherein the one or more instructions, when executed by at least one processor, further cause the at least one processor to generate an alert in response to determining that the coverage area of the unmelted batch material is outside the predetermined threshold range.

Clause 25: The computer program product according to any of clauses 19 to 24, wherein the alert is at least one of a visual alert and an audio alert.

Clause 26: The computer program product according to any of clauses 19 to 25, wherein the at least one characteristic of the image data is an image contrast value.

Clause 27: The computer program product according to any of clauses 19 to 26, wherein the at least one characteristic of the image data is an image brightness value.

Clause 28: The computer program product according to any of clauses 19 to 27, wherein the one or more zones are defined between an entrance and a bubbler area of the glass melt furnace.

Clause 29: The computer program product according to any of clauses 19 to 28, wherein the one or more zones comprise a fill zone at the entrance of the glass melt furnace, a bubbler zone at the bubbler area of the glass melt furnace, and an intermediate zone between the fill zone and the bubbler zone.

Clause 30: The computer program product according to any of clauses 19 to 29, wherein the one or more instructions, when executed by at least one processor, further cause the at least one processor to average the image data over a predefined period of time to account for heat-related disturbances in the image data.

Clause 31: A method for monitoring and control of unmelted batch material in a glass melt furnace, the method comprising: receiving, using at least one processor, image data of an interior of the glass melt furnace from at least one camera; defining, using the at least one processor, a region of interest in the image data, the region of interest corresponding to one or more zones in a glass melt portion in the interior of the glass melt furnace; identifying, using the at least one processor, a coverage area of the unmelted batch material in the one or more zones based on at least one characteristic of the image data; comparing the coverage area of the unmelted batch material with a predetermined setpoint; determining deviation, using the at least one processor, of the coverage area of the unmelted batch material from the predetermined setpoint; and, in response to deviation of the coverage area of the unmelted batch material from the predetermined setpoint, adjusting, using the at least one processor, a crown temperature distribution in a longitudinal direction of the interior of the glass melt furnace based on a temperature control model comprising: determining a desired temperature change in at least one of the one or more zones, the desired temperature change corresponding to a desired change in the coverage area of the unmelted batch material; and transforming the desired temperature change into a plurality of crown temperature trim setpoints using a temperature distribution matrix.

Clause 32: The method according to clause 31, wherein the temperature distribution matrix comprises a number of temperature trim multipliers corresponding to the plurality of crown temperature trim setpoints.

Clause 33: The method according to clauses 31 to 32, wherein the desired temperature change comprises a weighted fill side temperature change and a weighted waist side temperature change.

Clause 34: The method according to any of clauses 31 to 33, wherein the at least one action is increasing or decreasing a supply of gas to at least one burner.

Clause 35: The method according to any of clauses 31 to 34, further comprising: identifying a melt front of the unmelted batch material in each of the one or more zones based on at least one characteristic of the image data; comparing the melt front of the unmelted batch material with a predetermined melt front setpoint; determining deviation of the melt front of the unmelted batch material from the predetermined melt front setpoint; and, in response to deviation of the melt front of the unmelted batch material from the predetermined melt front setpoint, adjusting the crown temperature distribution using the temperature control model.

Clause 36: The method according to any of clauses 31 to 35, further comprising generating an alert in response to determining that the coverage area of the unmelted batch material is outside the predetermined threshold range.

Clause 37: The method according to any of clauses 31 to 36, wherein the alert is at least one of a visual alert and an audio alert.

Clause 38: The method according to any of clauses 31 to 37, wherein the at least one characteristic of the image data is an image contrast value.

Clause 39: The method according to any of clauses 31 to 38, wherein the at least one characteristic of the image data is an image brightness value.

Clause 40: The method according to any of clauses 31 to 39, wherein the one or more zones are defined between an entrance and a bubbler area of the glass melt furnace.

Clause 41: The method according to any of clauses 31 to 40, wherein the one or more zones comprise a fill zone at the entrance of the glass melt furnace, a bubbler zone at the bubbler area of the glass melt furnace, and an intermediate zone between the fill zone and the bubbler zone.

Clause 42: The method according to any of clauses 31 to 41, further comprising averaging the image data over a predefined period of time to account for heat-related disturbances in the image data.

With reference to FIG. 1, a float glass furnace 100 (hereinafter “furnace 100”) is shown in accordance with one embodiment or aspect of the present disclosure. The furnace 100 has a tank 102 contained within an enclosed chamber 104 made of refractory materials that are resistant to high temperatures. The furnace 100 has an input end 106 (also referred to herein as “fill end” or “fill side”) having at least one fill opening 108 through which batch materials are fed into the tank 102. Opposite the input end 106 is an output end 110 (also referred to herein as “waist end” or “waist side”) having at least one exit opening 112 through which molten glass exits the furnace 100. A plurality of burners 114 is positioned between the input end 106 and the output end 110 and extends into the interior of the enclosed chamber 104. The burners 114 may be provided on both lateral sides of the enclosed chamber 104. Each of the burners 114 is connected to a burner controller 116 configured for controlling the amount of fuel supplied to the burner 114. The burners 114 are spaced apart along a longitudinal length of the furnace 100 so as to distribute the energy supply over a major portion of the length of tank 102. One or more sensors 118 are provided to measure the temperature within the enclosed chamber 104. The one or more sensors 118 may be connected to the burner controller 116 to provide input for the burner controller 116 to control an output of the burners 114. A temperature profile within the enclosed chamber 104, viewed in a longitudinal direction of the furnace 100 between the input end 106 and the output end 110, as a result of burner 114 positioning and fuel supply is typically referred to as “crown temperature”.

With continued reference to FIG. 1, the furnace 100 includes a system 200 configured for monitoring and control of unmelted batch material in the furnace 100. The system 200 is configured to use real-time melt measurements and apply a model-based predictive control scheme to control the temperature within the enclosed chamber 104 in a manner that is optimized to produce molten glass with minimal or no defects while minimizing energy use to heat the enclosed chamber 104. The system 200 includes at least one camera 201 and at least one controller 202 configured for receiving image data from the at least one camera 201. In some embodiments or aspects, the at least one camera 201 may be a pair of cameras 201 provided on left and right sides at the output end 110 of the furnace 100. Each of the pair of cameras 201 may be connected to a common controller 202. Alternatively, each of the pair of cameras 201 may be connected to a separate controller 202.

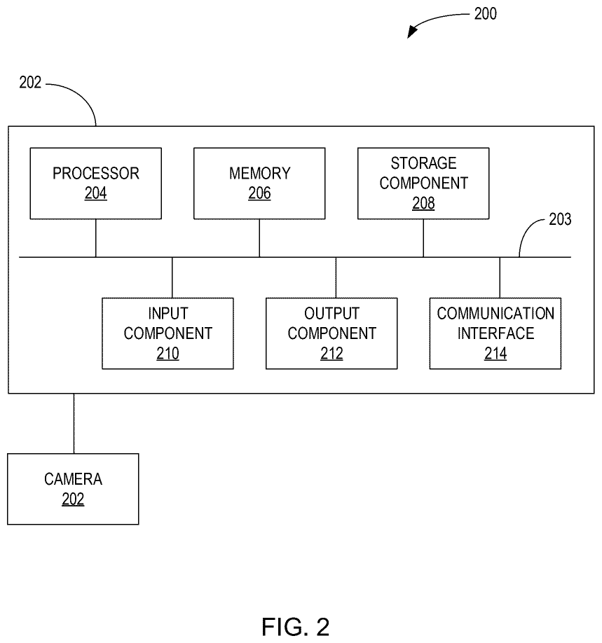

Referring now to FIG. 2, illustrated is a diagram of example components of the system 200. In some embodiments or aspects, the system 200 may include a bus 203, a processor 204, a memory 206, a storage component 208, an input component 210, an output component 212, and a communication interface 214.

The bus 203 may include a component that permits communication among the components of the system 200. In some non-limiting embodiments or aspects, the processor 204 may be implemented in hardware, software, or a combination of hardware and software. For example, the processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. The memory 206 may include random access memory (RAM), read-only memory (ROM), and/or another type of dynamic or static storage device (e.g., flash memory, magnetic memory, optical memory, etc.) that stores information and/or instructions for use by the processor 204.

The storage component 208 may store information and/or software related to the operation and use of device 200. For example, the storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

The input component 210 may include a component that permits the system 200 to receive information, such as via user input (e.g., a touchscreen display, a keyboard, a keypad, a mouse, a button, a switch, a microphone, a camera, etc.). Additionally or alternatively, the input component 210 may include a sensor (e.g., sensor 118) for sensing information (e.g., temperature information) and/or a camera (e.g., camera 201). The output component 212 may include a component that provides output information from system 200 (e.g., at least one display, speaker, light-emitting diodes (LEDs), etc.).

The communication interface 214 may include a transceiver-like component (e.g., a transceiver, a separate receiver and transmitter, etc.) that enables the system 200 to communicate with other devices, such as via a wired connection, a wireless connection, or a combination of wired and wireless connections. In some embodiments or aspects, the communication interface 214 may be configured to permit communication with the burner controller 116. The communication interface 214 may permit the system 200 to receive information from another device and/or provide information to another device. For example, the communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like. The communication interface 214 further may permit the system 200 to receive information from another device and/or provide information to another device over a communication network that may include one or more wired and/or wireless networks. For example, communication network may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of some or all of these or other types of networks.

The system 200 may perform one or more processes described herein. The system 200 may perform these processes based on the processor 204 executing software instructions stored by a computer-readable medium, such as the memory 206 and/or the storage component 208. A computer-readable medium (e.g., a non-transitory computer-readable medium) is defined herein as a non-transitory memory device. A non-transitory memory device includes memory space located inside of a single physical storage device or memory space spread across multiple physical storage devices.

Software instructions may be read into the memory 206 and/or the storage component 208 from another computer-readable medium or from another device via the communication interface 214. When executed, software instructions stored in the memory 206 and/or the storage component 208 may cause the processor 204 to perform one or more processes described herein. Additionally or alternatively, hardwired circuitry may be used in place of or in combination with software instructions to perform one or more processes described herein. Thus, embodiments or aspects described herein are not limited to any specific combination of hardware circuitry and software.

The memory 206 and/or the storage component 208 may include data storage or one or more data structures (e.g., a database, and/or the like). The system 200 may be capable of receiving information from, storing information in, communicating information to, or searching information stored in the data storage or one or more data structures in the memory 206 and/or the storage component 208. For example, the information may include data associated with a set of profiles, input data, output data, or any combination thereof.

The number and arrangement of components shown in FIG. 2 are provided as an example. In some non-limiting embodiments or aspects, the system 200 may include additional components, fewer components, different components, or differently arranged components than those shown in FIG. 2. Additionally or alternatively, a set of components (e.g., one or more components) of the system 200 may perform one or more functions described as being performed by another set of components of the system 200.

The number and arrangement of systems and/or devices shown in FIG. 2 are provided as an example. There may be additional systems and/or devices, fewer systems and/or devices, different systems and/or devices, or differently arranged systems and/or devices than those shown in FIG. 2. Furthermore, two or more systems and/or devices shown in FIG. 2 may be implemented within a single system or a single device, or a single system or a single device shown in FIG. 2 may be implemented as multiple, distributed systems or devices.

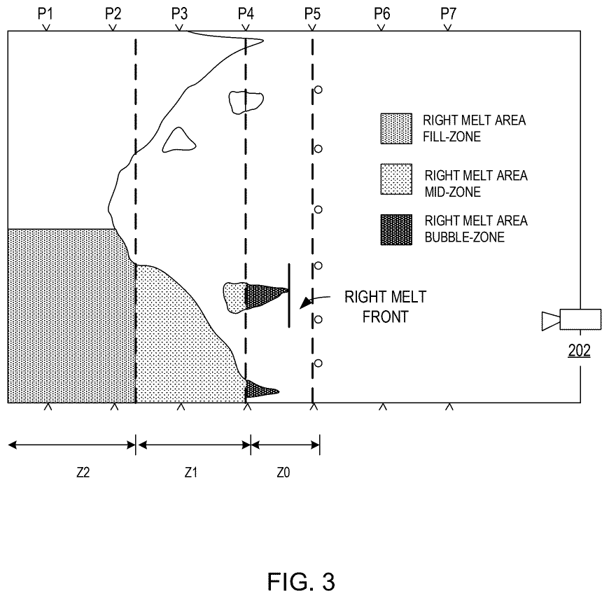

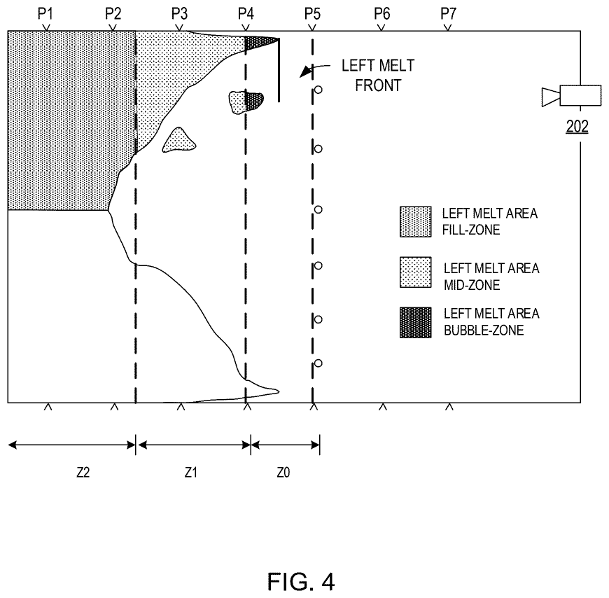

With reference to FIGS. 3-4, a top view of the furnace 100 is shown with the cameras 201 installed on left and right sides at the output end 110. While FIGS. 3-4 illustrate a pair of cameras 201, in some embodiments or aspects, the system 200 may have one or more than two cameras 201. For example, the system 200 may have a single camera 201 installed at the output end 110 of the furnace 100 or any other portion of the furnace 100.

Each camera 201 may be high temperature camera configured for use in the extreme temperature environment of the furnace 100. In some embodiments or aspects, the camera 201 may have a water-cooled jacket 220 provided within a metal tube 222 that is inserted through the wall of the output end 110 of the furnace 100. In some embodiments or aspects, the metal tube 222 may be made from Inconel. A nitrogen purge may be provided to cool the metal tube 222 and keep the lens of the camera 201 clean. In some embodiments or aspects, the camera 201 may be a visible light camera that is configured for taking black-and-white or color image data of the interior of the furnace 100. In further embodiments or aspects, the camera 201 may be an infrared camera configured to take image data in the infrared light spectrum. In some embodiments or aspects, the camera 201 may be made by JM Canty, Inc. of Buffalo, NY.

With continued reference to FIGS. 3-4, each camera 201 is configured to take image data of the interior of the furnace 100. In some embodiments or aspects, the left camera 201 may be configured to take image data of a left portion of the interior of the furnace 100, and the right camera 201 is configured to take image data of a right portion of the interior of the furnace 100. In further embodiments or aspects, the left camera 201 may be configured to take image data of right portion of the interior of the furnace 100, and the right camera 201 is configured to take image data of the left portion of the interior of the furnace 100. In various embodiments or aspects, image data taken by the cameras 201 may be combined using the controller 202 into a single image.

Image data may be used to determine unmelted portions of the batch material within a glass melt portion 120 of the furnace 100. Various characteristics of the image data, such as image contrast, brightness, and other characteristics, may be analyzed by the controller 202 to determine at least one characteristic of the melt condition, such as a melt coverage area and/or a melt front, that impacts the fuel use and glass quality. The controller 202 may utilize the image data to determine, for example, an optimal fuel burn rate for the burners 114 to avoid unmelted material from flowing too far downstream the glass melt portion 120 and creating defects in the final glass product. The presence of unmelted batch material past a predetermined longitudinal area in the furnace can be correlated to an increase in a number of glass defects.

In some embodiments or aspects, the coverage area/melt front values may be averaged over a predetermined period of time to account for heat-related disturbances in the image data. During firing of the one or more burners 114, image data may be skewed to indicate higher or lower coverage areas for the unmelted batch material relative to actual values of unmelted batch material due to heat output of the one or more burners 114. By averaging the coverage area/melt front values over a particular period of time, such heat-related disturbances during firing of the one or more burners 114 are eliminated from the image data. In embodiments or aspects where two cameras 201 are used, image data from the left camera can be averaged during a period of time during which the right side burners 114 are firing, and image data from the right camera can be averaged during a period of time during which the left side burners 114 are firing.

In some embodiments or aspects, the controller 202 may be configured to receive the image data from the at least one camera 201 and define a region of interest in the image data. In some embodiments or aspects, a minimum number of regions of interest in the image data is one. In further embodiments or aspects, a maximum number of regions of interest in the image data may be based on a number of burners. For example, and with reference to FIGS. 3-4, the region of interest may correspond to at least one zone (e.g., Z0, Z1, Z2, etc.) in the glass melt portion 120 of the interior of the furnace 100. In some embodiments or aspects, the at least one zone includes a fill zone Z2 at the input end 106 of the furnace, a bubbler zone Z0 at a bubbler area 126 of the furnace, and an intermediate zone Z1 between the fill zone Z2 and the bubbler zone Z0. In further embodiments or aspects, the at least one zone may correspond to an area proximate to each burner 114. In the embodiment or aspect shown in FIGS. 3-4, the fill zone Z2 may be defined in a space between the second and third burners 114 (P2, P3), the intermediate zone Z1 may be defined between the fourth burner 114 (P4) and a space between the second and third burners 114 (P2, P3), and the bubbler zone Z0 may be defined between the fourth and fifth burners 114 (P4, P5).

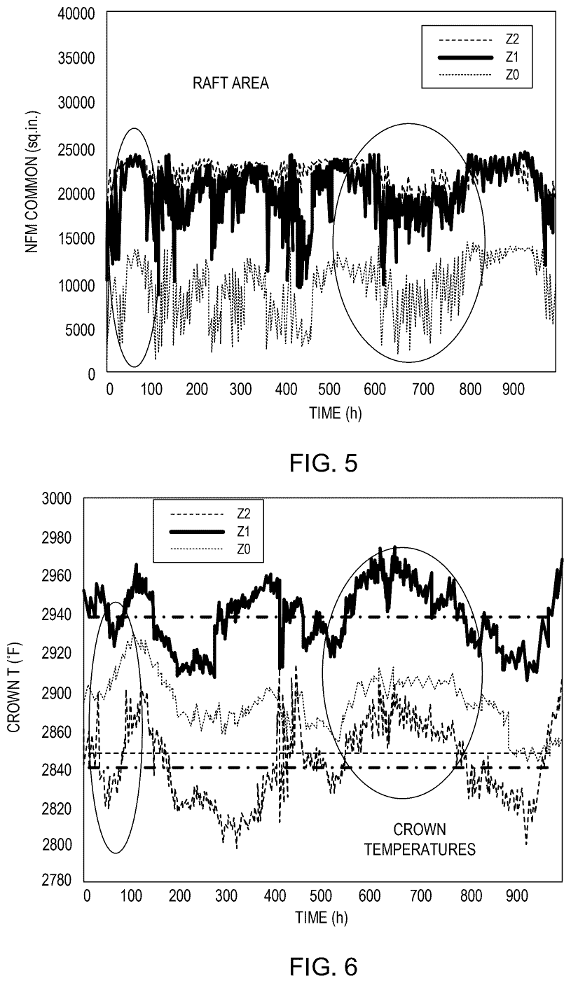

The image data from the region of interest may be used by the controller 202 to monitor and control one or more aspects of the furnace 100, as described herein. In general, the presence of unmelted batch material past the bubbler zone Z0 is undesirable because such presence can be correlated to an increase in a number of glass defects. As shown in FIGS. 5-6, variation in furnace crown temperature has a direct impact on the unmelted batch coverage, also referred to as the “raft area”. An increase in the raft area in a particular zone in the furnace 100 is correlated with a reduction in the crown temperature in that particular zone. Conversely, a decrease in the raft area correlates with an increase in the crown temperature. Thus, monitoring of the unmelted batch coverage is an important factor in controlling the operation of the furnace 100.

Referring back to FIGS. 3-4, unmelted batch material 122 is shown in shaded portions of the figures, while melted glass 124 is shown without shading. The coverage area of the unmelted batch material 122 decreases from the input end 106 to the output end 110 of the furnace 100. As shown in FIGS. 3-4, the fill zone Z2 is nearly completely filled with unmelted batch material 122, and the coverage of the unmelted batch material 122 decreases progressively in zone Z1 and zone Z2.

The unmelted batch material 122 appears in the image data as having a different shading compared to melted glass 124. In this manner, image data can be analyzed by the controller 202 to identify a coverage area of the unmelted batch material 122 in the region of interest. For example, each pixel in the image data can be assigned a value based on the characteristics of the image data (e.g., brightness, contrast), and this value can be assigned as being correlative of unmelted batch material 122 or melted glass 124. By adding up all of the pixels in the image data having the same assigned value, a total coverage area of unmelted batch material 122 can be determined relative to the total coverage area of melted glass 124. The total coverage area can be further segmented into zones, such as zones Z0-Z2 discussed herein. Furthermore, image data can be analyzed by the controller 202 to identify a front of the unmelted batch material 122 (also referred to herein as “raft front”) in the region of interest.

Coverage area of the unmelted batch material 122 in at least one particular zone, such as the bubbler zone Z0, can be used by the controller 202 for adjusting the crown temperature distribution of the furnace 100 using a temperature control model, as described herein. In some embodiments or aspects, the coverage area of the unmelted batch material 122, such as the total coverage area or a coverage area in one or more zones, can be compared with a predetermined setpoint that is configured to optimize fuel use while minimizing glass defects. In other words, the temperature control model is configured to balance efficiency and glass quality. Using the coverage area of the unmelted batch material 122 as an input, the controller 202 may be configured to output a control signal, such as a signal to the burner controller 116, to control operation of the one or more burners 116 to achieve a desired crown temperature profile.

With reference to FIGS. 5-6, raft area, expressed in, for example, in², and crown temperature, expressed in, for example, OF, are shown as functions of time, respectively. FIGS. 5-6 show a correlation of raft area and furnace temperature. In FIG. 5, data is shown at 3 zones in a region of interest, wherein “Fill Zone” corresponds to a raft area in Zone 2 described herein, “Mid Zone” corresponds to a raft area in Zone 1 described herein, and “Bubbler Zone” corresponds to a raft area in Zone 0 described herein. Similarly, in FIG. 6, data is shown at 3 zones in a region of interest, wherein “TC Fill” corresponds to a temperature in Zone 2 described herein, “TC-Peak” corresponds to a temperature in Zone 1 described herein, and “TC-Waist” corresponds to a temperature in Zone 0 described herein. In a circled area 126 in FIGS. 5-6, it is apparent that an increase in the raft area generally correlates with a decrease in temperature. Similarly, as shown in in a circled area 128 in FIGS. 5-6, a decrease in the raft area generally correlates with an increase in temperature.

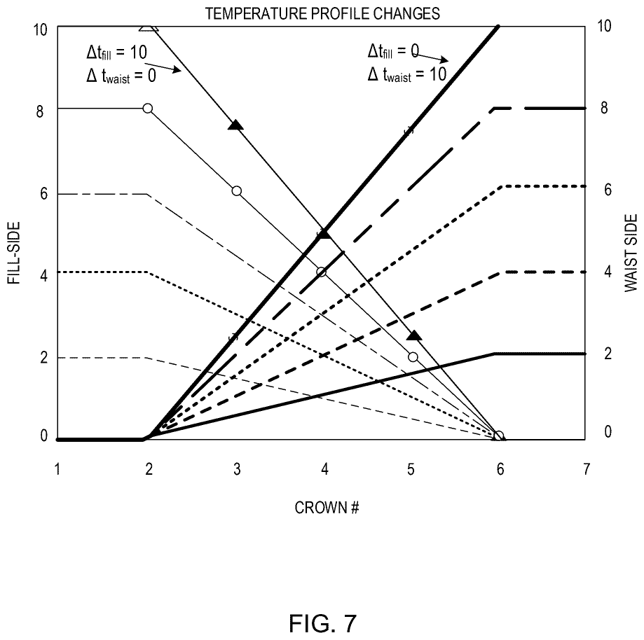

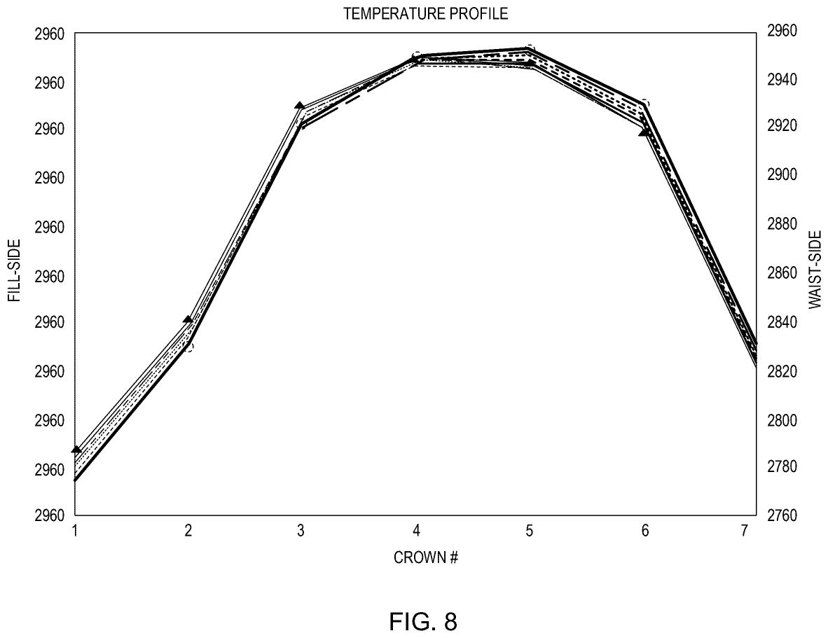

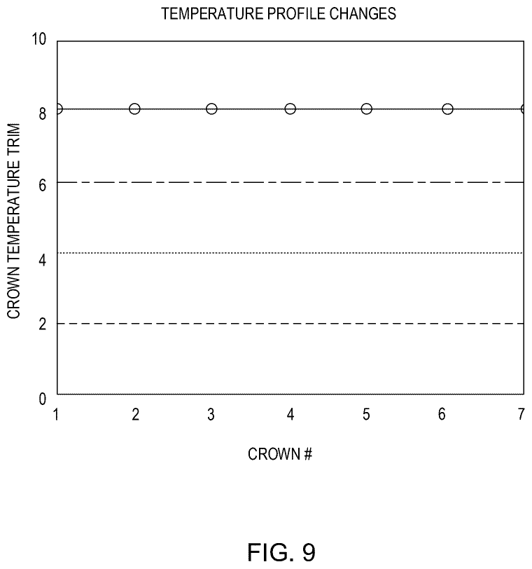

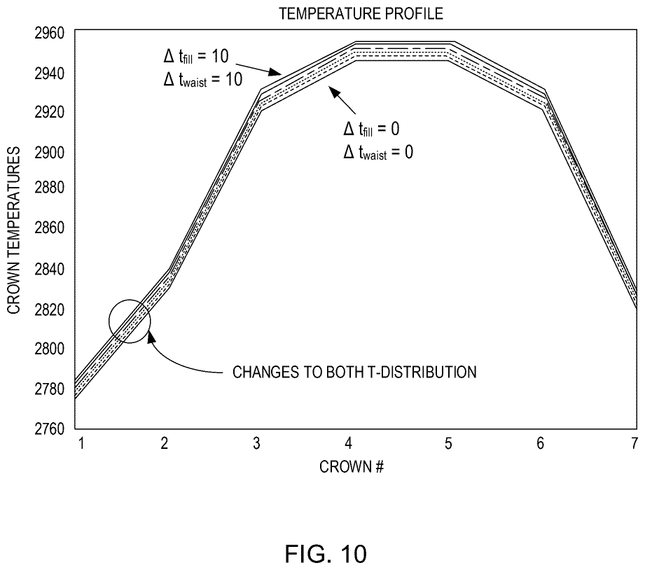

In order to develop a predictive temperature control model that is configured to trim the desired crown temperatures based on the melt condition, empirical data is collected to learn from process responses. With reference to FIGS. 7-10, furnace “bump” tests are conducted in which the crown temperature of the furnace is deliberately changed in a manner to maximize a potential impact on melt behavior. FIG. 7 is a plot of temperature change of 10° F. at a fill side that is scaled down to 0 at the waist side. FIG. 7 further includes a plot of temperature change of 10° F. at the waist side that is scaled down to 0 at the fill side. The resulting crown temperature profiles are shown in FIG. 8, where it can be observed that the fill side temperature distribution (crown numbers 1-4) is progressively increased while the waist side temperature distribution (crown numbers 4-7) remains substantially unchanged when the furnace temperature is progressively “bumped” at the fill end. Similarly, FIG. 8 shows that the crown temperature profile at the fill end is substantially unchanged and it progressively increases at the waist end when the furnace temperature is progressively “bumped” at the waist end. FIGS. 9-10 show a progressive temperature increase at both fill and waist ends if the crown temperature profile is “bumped” at both ends.

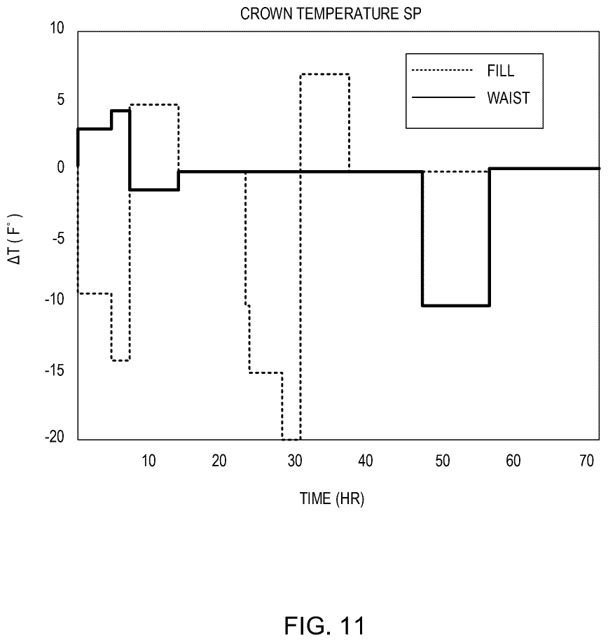

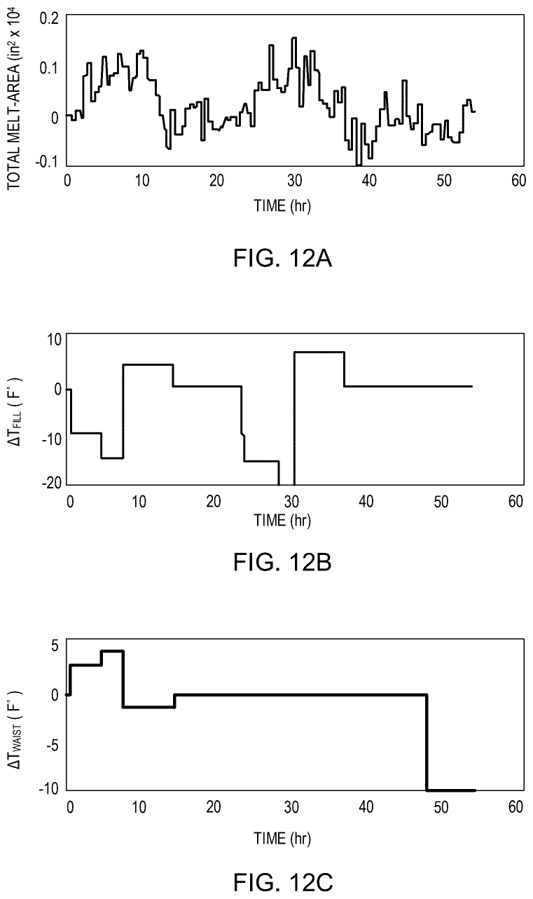

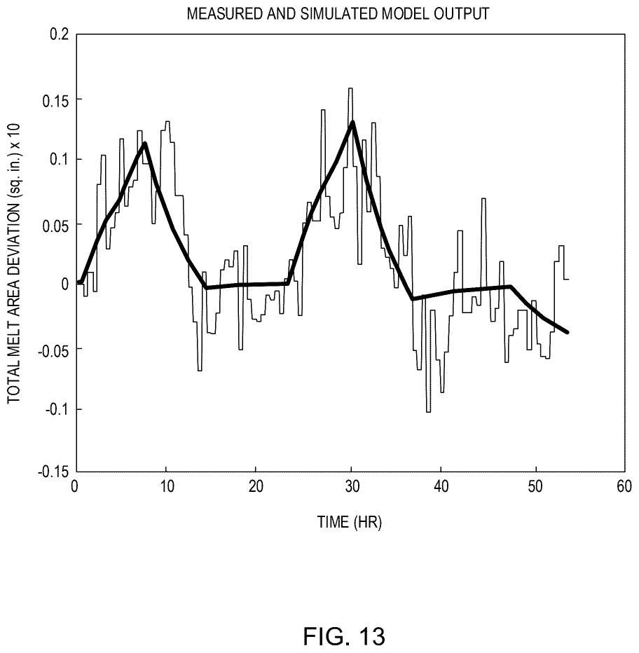

FIG. 11 shows the changes in the fill side temperatures and waist side temperatures from a plurality of “bump” tests as a function of time. While FIG. 11 illustrates the temperature changes to both the fill side and the waist side, FIGS. 12B and 12C, respectively, show the temperature changes on each side individually. During these tests, deviations in the total raft area are measured and plotted as a function of time in FIGS. 12A and 13. In FIG. 13, the measured changes in the total raft area are plotted and a simulated model output is fit to this data using a first-order plus dead-time dynamic modelling strategy. In this manner, a control technique is developed using a mathematical model of the system to make predictions about the future behavior of the raft area in response to changes in the fill and waist side temperatures. From these predictions, the system 200 is configured to determine control actions for controlling operation of the furnace 100. Accordingly, instead of adjusting individual temperatures at each setpoint in the crown temperature, the temperature control model relies on two manipulated variables (desired fill and waist side temperature changes).

In some embodiments or aspects, based on deviation of the coverage area and/or the melt front of the unmelted batch material from the predetermined setpoint, the system 200 may be configured to adjust the crown temperature distribution based on a temperature control model that determines a desired temperature change in at least one of the zones that would produce a desired effect in reducing or increasing the coverage area and/or the melt front. The desired temperature change corresponds to a desired change in the coverage area and/or melt front of the unmelted batch material, as determined by the model using empirical data. In some embodiments or aspects, the temperature control model may consider two variables, with the first variable being a fill side temperature distribution that is weighted toward the fill end of the furnace, while the second variable is a waist side temperature distribution that is more weighted toward the waist end of the furnace. The desired temperature change can be transformed into a plurality of crown temperature trim setpoints using a temperature distribution matrix. In some embodiments or aspects, the temperature distribution matrix may include a number of temperature trim multipliers corresponding to the plurality of crown temperature trim setpoints.

An exemplary equation for determining the crown temperature trim setpoints based on the desired temperature changes can be represented as a square matrix shown below as Equation (1)

$${[ \begin{matrix}Δ {T}_{1}^{SP} \\ Δ {T}_{2}^{SP} \\ Δ {T}_{3}^{SP} \\ \\ ⋮ \\ \\ Δ {T}_{7}^{SP}\end{matrix} ]}_{ES 3} = [ \begin{matrix}1 & 0 \\ 1 & 0 \\ 1 & 0.2 \\ 0.8 & 0.6 \\ 0.5 & 1 \\ 0.2 & 0.6 \\ 0 & 0.2\end{matrix} ] \times [ \begin{matrix}Δ {T}_{fill} \\ Δ {T}_{waist}\end{matrix} ] \qquad Equation ( 1 )$$

In the above exemplary equation, there are 7 possible crown temperature trim setpoints (ΔT₁^{SP} to ΔT₇^{SP}) corresponding, for example to 7 burners. In other systems, the number of crown temperature trim setpoints may be higher or lower, depending on the number of burners. For example, in a furnace 100 having 7 burners 114, there are 7 possible adjustments to be made to the crown temperature. The crown temperature trim setpoints are a product of the manipulated variables (ΔT_{fill} and ΔT_{waist}) and the temperature distribution matrix that includes a number of temperature trim multipliers that corresponds to the number of crown temperature trim setpoints (i.e., 7). The temperature distribution matrix is weighed toward the fill side in the first column and toward the waist side in the second column. In some embodiments or aspects, the multipliers in the temperature distribution matrix are non-dimensional values between 0 and 1, and are chosen by an operator based on a desired weighing toward the fill or waist side.

In some embodiments or aspects, the temperature control model may be configured to trim the desired temperatures based on the melt condition and/or melt front determined from image data from the one or more cameras 201. For example, the controller 202, such as the processor 204, may receive the image data from the one or more cameras 201, and identify a coverage area of the unmelted batch material and/or a melt front of the unmelted batch material in each of the one or more zones based on at least one characteristic of the image data. For example, the identification of the coverage area and/or melt front may be based on the contrast, brightness, or other characteristics in the image data in a region of interest. The controller 202, such as the processor 204, is then configured to compare the computed coverage area and/or melt front of the unmelted batch material with a predetermined setpoint, and determine the deviation of the coverage area and/or the melt front of the unmelted batch material from the predetermined setpoint. The predetermined setpoint may be preset based on prior experience. In response to determining the extent of deviation of coverage area and/or the melt front of the unmelted batch material from the predetermined setpoint, the controller 202, such as the processor 204, may be configured to adjust the crown temperature distribution based on the temperature control model discussed herein. In some embodiments or aspects, the controller 202, such as the processor 204, may be programmed or configured to generate an alert in response to determining that the coverage area and/or the melt front of the unmelted batch material is outside the predetermined threshold range. The alert may be a visual alert, such as a message output on the output component 212 that is a display, and/or an audio alert, such as a sound output on the output component 212 that is a speaker.

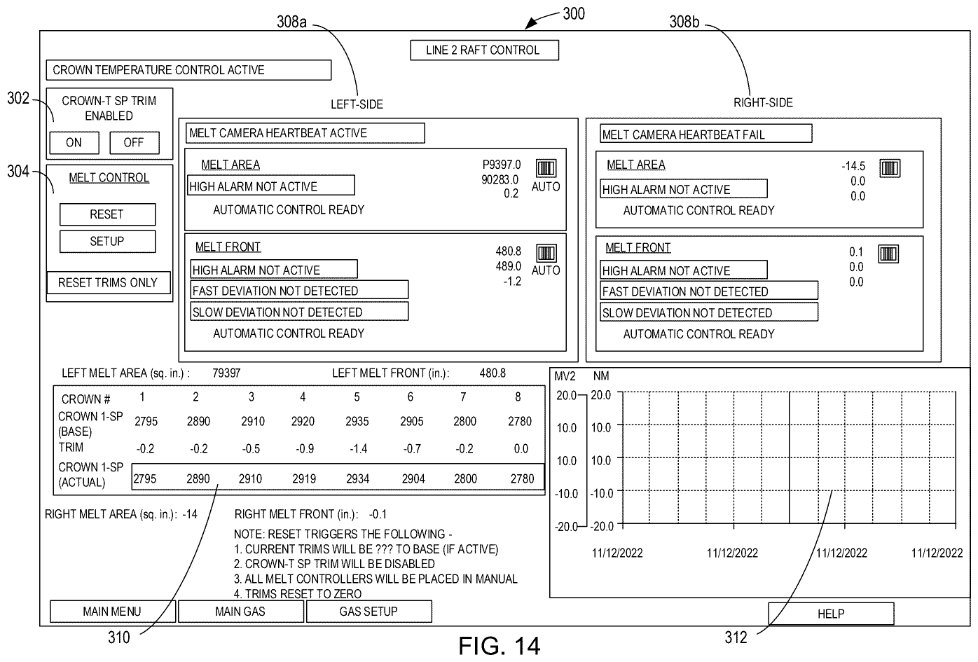

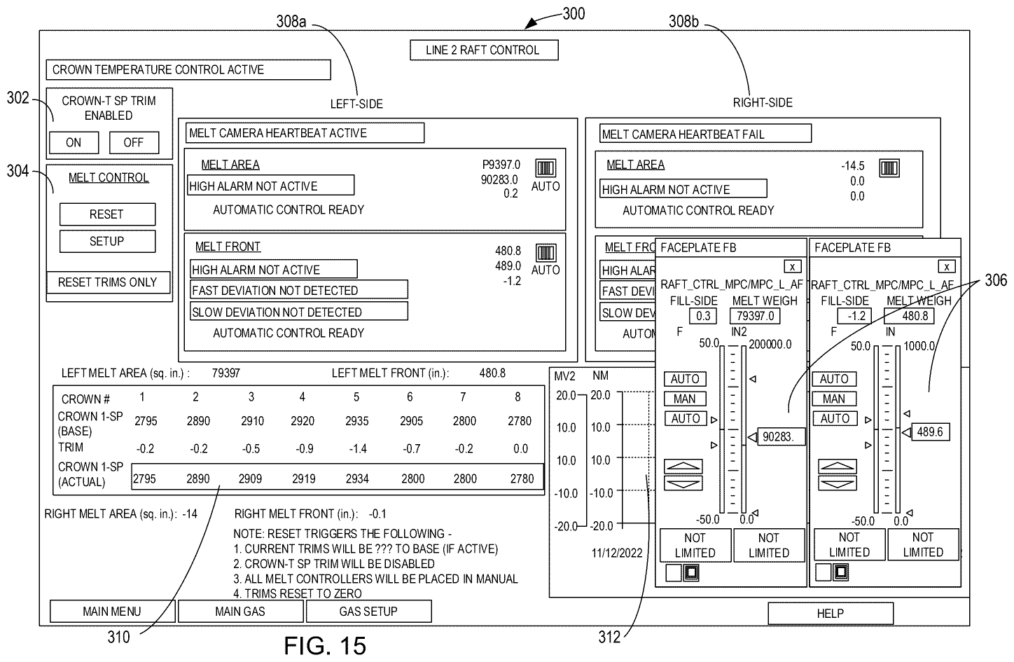

With reference to FIGS. 14 and 15, an exemplary graphical user interface (GUI) 300 for monitoring and control of unmelted batch material is shown in accordance with some embodiments or aspects. The GUI 300 may be configured as an input component 210 (shown in FIG. 2) for inputting information to the controller 202 (shown in FIG. 2) and/or an output component 212 (shown in FIG. 2) for outputting information from the controller 202. In some embodiments or aspects, the GUI 300 can be displayed on a display, such as a touchscreen display.

With continued reference to FIGS. 14 and 15, the GUI 300 includes an operation control portion 302 wherein control of crown temperature setpoints is enabled or disabled. The operation control portion 302 may include one or more buttons to enable or disable crown temperature control. The GUI 300 further may include a setup portion 304, wherein the user may choose to reset the melt control settings to a default, or set customized melt control settings. By clicking on the “Setup” button in the setup portion 304, the user is presented with an adjustment screen 306 (FIG. 15), wherein the melt area and/or melt front setpoints and/or thresholds can be adjusted.

With continued reference to FIGS. 14 and 15, the GUI 300 further includes camera status portions 308a, 308b for displaying status information of the cameras 201 (shown in FIG. 1). The camera status portions 308a, 308b may be configured to display information regarding the on/off status of the cameras, and characteristics of the image data relating to the coverage area of the unmelted batch material and/or the melt front of the unmelted batch material. The GUI 300 further includes a crown temperature information portion 310, wherein information relating to the crown temperatures measured by one or more sensors is displayed in addition to crown temperature trim setpoints. In some embodiments or aspects, the GUI 300 includes a graphical output portion 312 configured for outputting a plot of selected measured values as a function of time. For example, the graphical output portion 312 may be configured to display the fill and waist side temperature trims as a function of time.

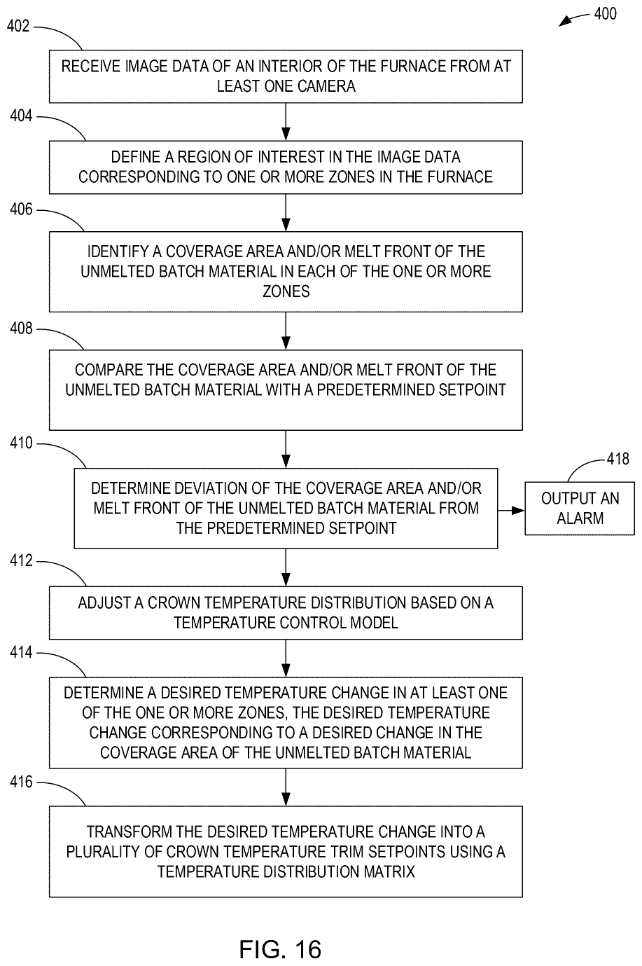

Referring now to FIG. 16, illustrated is a flowchart of a non-limiting aspect or embodiment of a process 400 for of monitoring and controlling unmelted batch material in a glass melt furnace. In some non-limiting embodiments or aspects, one or more of the functions described with respect to process 400 may be performed (e.g., completely, partially, etc.) by the system 200, such as the at least one camera 201 and the controller 202. In some non-limiting embodiments or aspects, one or more of the steps of process 400 described below may be performed (e.g., completely, partially, and/or the like) by another device or a group of devices separate from and/or including the system 200, such as the at least one camera 201 and the controller 202.

With reference to FIG. 16, at step 402, the method 400 may include receiving, using the processor 204, image data of an interior of the furnace 100 from at least one camera 201. At step 404, the processor 204 is configured to define a region of interest in the image data, wherein the region of interest corresponds to one or more zones in in the interior of the furnace 100. At step 406, the processor 204 is configured to identify a coverage area of the unmelted batch material in the one or more zones based on at least one characteristic of the image data. The processor 204 is then configured to, at step 408 to compare the coverage area of the unmelted batch material with a predetermined threshold range. At step 410, the processor 204 is configured to determine whether the coverage area of the unmelted batch material is outside the predetermined threshold range. In response to determining that the coverage area of the unmelted batch material is outside the predetermined threshold range, the processor 204 is configured to, at step 412, to adjust the crown temperature distribution based on a temperature control discussed herein. For example, at step 414, the processor 204 may be configured to determine a desired temperature change in at least one of the one or more zones, with the desired temperature change corresponding to a desired change in the coverage area of the unmelted batch material. At step 416, the processor 204 is configured to transform the desired temperature change into a plurality of crown temperature trim setpoints using a temperature distribution matrix. At step 418, the processor 204 is further programmed or configured to generate an alert in response to determining that the coverage area of the unmelted batch material is outside the predetermined threshold range.

Although the above methods, systems, and computer program products have been described in detail for the purpose of illustration based on what are currently considered to be the most practical and preferred embodiments or aspects, it is to be understood that such detail is solely for that purpose and that the present disclosure is not limited to the described embodiments or aspects but, on the contrary, is intended to cover modifications and equivalent arrangements that are within the spirit and scope of the appended claims. For example, it is to be understood that the present disclosure contemplates that, to the extent possible, one or more features of any embodiment or aspect can be combined with one or more features of any other embodiment or aspect.

What is claimed is:

1. A system for monitoring and control of unmelted batch material in a glass melt furnace, the system comprising:
at least one camera configured to take image data of an interior of the glass melt furnace; and
at least one processor, wherein the at least one processor is programmed or configured to:
receive the image data from the at least one camera;
define a region of interest in the image data, the region of interest corresponding to one or more zones in a glass melt portion in the interior of the glass melt furnace;
identify a coverage area of the unmelted batch material in each of the one or more zones based on at least one characteristic of the image data;
compare the coverage area of the unmelted batch material with a predetermined setpoint;
determine deviation of the coverage area of the unmelted batch material from the predetermined setpoint; and
in response to deviation of the coverage area of the unmelted batch material from the predetermined setpoint, adjust a crown temperature distribution in a longitudinal direction of the interior of the glass melt furnace based on a temperature control model comprising:
determining a desired temperature change in at least one of the one or more zones, the desired temperature change corresponding to a desired change in the coverage area of the unmelted batch material; and
transforming the desired temperature change into a plurality of crown temperature trim setpoints using a temperature distribution matrix.

2. The system according to claim 1, wherein the temperature distribution matrix comprises a number of temperature trim multipliers corresponding to the plurality of crown temperature trim setpoints.

3. The system according to claim 1, wherein the desired temperature change comprises a weighted fill side temperature change and a weighted waist side temperature change.

4. The system according to claim 1, wherein adjusting the crown temperature distribution comprises increasing or decreasing a supply of gas to at least one burner.

5. The system according to claim 1, wherein the at least one processor is further programmed or configured to:
identify a melt front of the unmelted batch material in each of the one or more zones based on at least one characteristic of the image data;
compare the melt front of the unmelted batch material with a predetermined melt front setpoint;
determine deviation of the melt front of the unmelted batch material from the predetermined melt front setpoint; and
in response to deviation of the melt front of the unmelted batch material from the predetermined melt front setpoint, adjust the crown temperature distribution using the temperature control model.

6. The system according to claim 1, wherein the at least one processor is programmed or configured to generate an alert in response to determining that the coverage area of the unmelted batch material is outside the predetermined threshold range.

7. The system according to claim 1, wherein the alert is at least one of a visual alert and an audio alert.

8. The system according to claim 1, wherein the at least one characteristic of the image data is an image contrast value.

9. The system according to claim 1, wherein the at least one characteristic of the image data is an image brightness value.

10. The system according to claim 1, wherein the one more zones is defined between an entrance and a bubbler area of the glass melt furnace.

11. The system according to claim 10, wherein the one or more zones comprise a fill zone at the entrance of the glass melt furnace, a bubbler zone at the bubbler area of the glass melt furnace, and an intermediate zone between the fill zone and the bubbler zone.

12. The system according to claim 1, wherein the at least one processor is programmed or configured to average the image data over a predefined period of time to account for heat-related disturbances in the image data.

13. The system according to claim 1, wherein the at least one camera is a pair of cameras positioned at an exit of the glass melt furnace.

14. The system according to claim 1, wherein the at least one camera comprises a liquid-cooled jacket.

15. The system according to claim 14, wherein the liquid-cooled jacket comprises a nitrogen purge for cleaning a lens of the at least one camera.

16. The system according to claim 1, wherein the at least one camera operates in a visible light spectrum.

17. The system according to claim 1, wherein the at least one camera is configured to take black and white still or video images of the interior of the glass melt furnace.

18. The system according to claim 1, wherein the at least one camera is configured to take color still or video images of the interior of the glass melt furnace.

19. A computer program product for monitoring and control of unmelted batch material in a glass melt furnace, the computer program product comprising at least one non-transitory computer-readable medium including one or more instructions that, when executed by at least one processor, cause the at least one processor to:
receive image data of an interior of the glass melt furnace from at least one camera;
define a region of interest in the image data, the region of interest corresponding to one or more zones in a glass melt portion in the interior of the glass melt furnace;
identify a coverage area of the unmelted batch material in each of the one or more zones based on at least one characteristic of the image data;
compare the coverage area of the unmelted batch material with a predetermined setpoint;
determine deviation of the coverage area of the unmelted batch material from the predetermined setpoint; and
in response to deviation of the coverage area of the unmelted batch material from the predetermined setpoint, adjust a crown temperature distribution in a longitudinal direction of the interior of the glass melt furnace based on a temperature control model comprising:
determining a desired temperature change in at least one of the one or more zones, the desired temperature change corresponding to a desired change in the coverage area of the unmelted batch material; and
transforming the desired temperature change into a plurality of crown temperature trim setpoints using a temperature distribution matrix.

20. A method for monitoring and control of unmelted batch material in a glass melt furnace, the method comprising:
receiving, using at least one processor, image data of an interior of the glass melt furnace from at least one camera;
defining, using the at least one processor, a region of interest in the image data, the region of interest corresponding to one or more zones in a glass melt portion in the interior of the glass melt furnace;
identifying, using the at least one processor, a coverage area of the unmelted batch material in the one or more zones based on at least one characteristic of the image data;
comparing the coverage area of the unmelted batch material with a predetermined setpoint;
determining deviation, using the at least one processor, of the coverage area of the unmelted batch material from the predetermined setpoint; and
in response to deviation of the coverage area of the unmelted batch material from the predetermined setpoint, adjusting, using the at least one processor, a crown temperature distribution in a longitudinal direction of the interior of the glass melt furnace based on a temperature control model comprising:
determining a desired temperature change in at least one of the one or more zones, the desired temperature change corresponding to a desired change in the coverage area of the unmelted batch material; and
transforming the desired temperature change into a plurality of crown temperature trim setpoints using a temperature distribution matrix.
